(19) United States
(12) Patent Application Publication
(10) Pub. No.: US 2026/0237631 A1
(43) Pub. Date: Aug. 13, 2026

(54) FORMATION METHOD FOR ALL-SOLID-STATE LITHIUM SECONDARY BATTERY

(71) Applicant: HONDA MOTOR CO., LTD., Tokyo (JP)

(72) Inventors: Kyohei IZUMI, Saitama (JP); Takashi NAKAGAWA, Saitama (JP); Shuntaroh UJIIE, Saitama (JP)

(21) Appl. No.: 19/530,354

(22) Filed: Feb. 5, 2026

(30) Foreign Application Priority Data
Feb. 7, 2025 (JP) 2025-019635

(51) Int. Cl. H01M 4/04; H01M 10/052

(52) U.S. Cl. CPC H01M 4/0445; H01M 10/052

(57) ABSTRACT

A formation method for an all-solid-state lithium secondary battery according to one embodiment of the present invention, the battery including a positive electrode layer, a negative electrode layer, and a solid electrolyte layer disposed between the positive electrode layer and the negative electrode layer, in which the positive electrode layer has a positive electrode current collector, and a positive electrode active material layer, the negative electrode layer has a metal film, the metal film is disposed at a position facing the positive electrode active material layer, and lithium is deposited on a surface of the metal film during charging, the method including performing charging at least once, in which an average charging current density in the charging for a first time falls within a range of 3.0 mA/cm² or more and 14.0 mA/cm² or less per area of a portion of the metal film facing the positive electrode active material layer.

This application is based on and claims the benefit of priority from Japanese Patent Application No. 2025-019635, filed on 7 Feb. 2025, the content of which is incorporated herein by reference.

### BACKGROUND OF THE INVENTION

### Field of the Invention

The present invention relates to a formation method for an all-solid-state lithium secondary battery.

### Related Art

In recent years, research and development has been carried out on secondary batteries that contribute to energy efficiency in order for more people to be able to ensure access to energy that is reasonable, reliable, sustainable, and advanced. As such a secondary battery, an all-solid-state lithium secondary battery is known. The all-solid-state lithium secondary battery includes a positive electrode layer, a negative electrode layer, and a solid electrolyte layer disposed between the positive electrode layer and the negative electrode layer. As the all-solid-state lithium secondary battery, a battery has been studied, in which during charging, metallic lithium is deposited on a negative electrode layer using a metal material that does not form an alloy with lithium for a material of the negative electrode layer (for example, see Patent Document 1 and Patent Document 2). In particular, an all-solid-state lithium secondary battery in which metallic lithium is deposited on a negative electrode current collector using, as the negative electrode current collector, a metal film made of the metal material that does not form an alloy with lithium is also referred to as an anode-free battery (for example, see Patent Document 1). In the all-solid-state lithium secondary battery, in general, charging and discharging is performed on the battery immediately after production, and a formation process is performed to stabilize the positive electrode layer and the negative electrode layer.
Patent Document 1: PCT International Publication No. WO2022/070326
Patent Document 2: U.S. Patent Application, Publication No. 2022/0115640

### SUMMARY OF THE INVENTION

By the way, in a technology related to an all-solid-state lithium secondary battery, objects are to achieve a high capacity and improve cycle characteristics. The anode-free battery has a capacity per unit capacity that can be increased more easily than a battery in which a negative electrode active material occluding and releasing lithium is used as a material of the negative electrode layer. Therefore, in the anode-free battery, it is desired to improve the cycle characteristics.

An object of the present invention is to provide a formation method that can improve cycle characteristics of an all-solid-state lithium secondary battery configured to deposit lithium on a surface of a metal film of a negative electrode layer during charging. Accordingly, the present invention contributes to energy efficiency.

The present inventors have found that, when the formation process is performed on the all-solid-state lithium secondary battery, a current density of the charging for the first time falling within a predetermined range is effective for achieving the above-described object, and have completed the present invention. Therefore, the present invention provides the following.

(1) A formation method for an all-solid-state lithium secondary battery including a positive electrode layer, a negative electrode layer, and a solid electrolyte layer disposed between the positive electrode layer and the negative electrode layer, in which the positive electrode layer has a positive electrode current collector, and a positive electrode active material layer, the negative electrode layer has a metal film, the metal film is disposed at a position facing the positive electrode active material layer, and lithium is deposited on a surface of the metal film during charging, is provided. The method includes performing charging at least once, in which an average charging current density in the charging for a first time falls within a range of 3.0 mA/cm² or more and 14.0 mA/cm² or less per area of a portion of the metal film facing the positive electrode active material layer.

According to the formation method for an all-solid-state lithium secondary battery described in (1), since a metallic lithium layer having a uniform thickness is formed on the surface of the metal film of the negative electrode layer by the charging for the first time, the surface of the metal film is uniformly activated. Therefore, the cycle characteristics of the all-solid-state lithium secondary battery after the formation process are improved.

(2) In the formation method for an all-solid-state lithium secondary battery as described in (1) above, the charging for the first time is performed until a state of charge of the all-solid-state lithium secondary battery reaches at least 30%.

According to the formation method for an all-solid-state lithium secondary battery described in (2), since the surface of the metal film is uniformly activated more reliably, the cycle characteristics of the all-solid-state lithium secondary battery after the formation process are further improved.

(3) In the formation method for an all-solid-state lithium secondary battery as described in (1) or (2) above, after the charging for the first time, the all-solid-state lithium secondary battery is discharged, and then, charging for a second time is performed on the all-solid-state lithium secondary battery under a condition that an average charging current density is within a range of 3.0 mA/cm² or more and 14.0 mA/cm² or less per area of a portion of the metal film facing the positive electrode active material layer.

According to the formation method for an all-solid-state lithium secondary battery described in (3), since the surface of the metal film is further uniformly activated by the charging for the second time, the cycle characteristics of the all-solid-state lithium secondary battery after the formation process are further improved.

(4) In the formation method for an all-solid-state lithium secondary battery as described in any one of (1) to (3) above, the metal film is a film of a metal that does not form an alloy with lithium.

According to the formation method for an all-solid-state lithium secondary battery described in (4), since lithium is easily deposited on the surface of the metal film during charging, the cycle characteristics of the all-solid-state lithium secondary battery after the formation process are further improved.

(5) In the formation method for an all-solid-state lithium secondary battery as described in (4) above, the metal film is a copper film.

According to the formation method for an all-solid-state lithium secondary battery described in (5), since lithium is easily deposited on the surface of the metal film more reliably during charging, the cycle characteristics of the all-solid-state lithium secondary battery after the formation process are further improved.

(6) In the formation method for an all-solid-state lithium secondary battery as described in any one of (1) to (5) above, the all-solid-state lithium secondary battery has a negative electrode tab, and the negative electrode tab is connected to the metal film.

According to the formation method for an all-solid-state lithium secondary battery described in (6), since the all-solid-state lithium secondary battery is an anode-free battery in which a metal film acts as a negative electrode current collector, a capacity per unit capacity can be increased easily.

According to the present invention, it is possible to provide a formation method that can improve cycle characteristics of an all-solid-state lithium secondary battery configured to deposit lithium on a surface of a metal film of a negative electrode layer during charging.

### BRIEF DESCRIPTION OF THE DRAWINGS

FIG. 1 is a cross-sectional view illustrating an all-solid-state lithium secondary battery that can be used for a formation method for an all-solid-state lithium secondary battery according to one embodiment of the present invention;

FIG. 2A is a cross-sectional view illustrating an example of a state at an initial time in charging for a first time in the formation method for an all-solid-state lithium secondary battery according to one embodiment of the present invention;

FIG. 2B is a cross-sectional view illustrating an example of a state at an intermediate time in the charging for the first time in the formation method for an all-solid-state lithium secondary battery according to one embodiment of the present invention;

FIG. 2C is a cross-sectional view illustrating an example of a state at an end time in the charging for the first time in the formation method for an all-solid-state lithium secondary battery according to one embodiment of the present invention;

FIG. 3 is a graph showing an example of a charging and discharging pattern in the formation method for an all-solid-state lithium secondary battery according to one embodiment of the present invention; and

FIG. 4 is a graph showing a relationship between a cycle number and a discharge capacity retention rate of an all-solid-state battery in each of Examples 1 to 3 and Comparative Examples 1 and 2.

### DETAILED DESCRIPTION OF THE INVENTION

Hereinafter, a formation method for an all-solid-state lithium secondary battery according to one embodiment of the present invention will be described with reference to the drawings.

First, a configuration of an all-solid-state battery as an object of the formation method of the present embodiment.

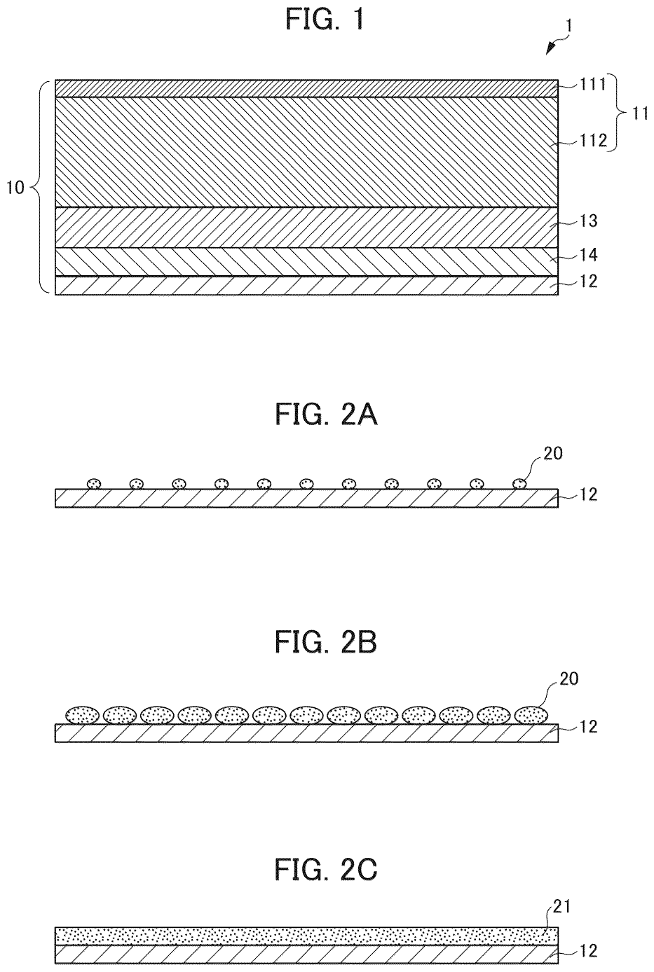

FIG. 1 is a cross-sectional view illustrating an all-solid-state lithium secondary battery that can be used for the formation method for an all-solid-state lithium secondary battery according to one embodiment of the present invention.

An all-solid-state lithium secondary battery 1 has an electrode laminate 10. The electrode laminate 10 is a laminate in which a positive electrode layer 11, a negative electrode layer 12, a solid electrolyte layer 13 disposed between the positive electrode layer 11 and the negative electrode layer 12, and an intermediate layer 14 disposed between the solid electrolyte layer 13 and the negative electrode layer 12. The electrode laminate 10 is housed in an exterior housing body (not illustrated) that includes a positive electrode tab and a negative electrode tab.

The positive electrode layer 11 has a positive electrode current collector 111, and a positive electrode active material layer 112 disposed on a surface of the positive electrode current collector 111. The positive electrode current collector 111 is connected to the positive electrode tab (not illustrated).

The positive electrode current collector 111 is in the form of, for example, foil, a plate, mesh, non-woven fabric, a foam, or the like. Examples of the material for the positive electrode current collector 111 include aluminum, an aluminum alloy, stainless steel, nickel, iron, and titanium.

The positive electrode active material layer 112 includes a positive electrode active material. The positive electrode active material may be a lithium compound that releases lithium ions during charging and occludes lithium ions during discharging. A layered active material, a spinel-type active material, or an olivine-type active material, for example, can be used as the lithium compound. Specific examples of the positive electrode active material include lithium cobalt oxide (LiCoO₂), lithium nickelate (LiNiO₂), lithium nickel manganese cobalt oxide (NMC: LiNiₚMn_{q}CoᵣO₂ (where p+q+r=1)), LiNiₚAl_{q}CoᵣO₂ (where p+q+r=1), lithium manganate (LiMn₂O₄), heterogeneous element substituted Li—Mn spinel represented by Li₁₊ₓMn_{2-x-y}M_{y}O₄ (where x+y=2, and M is at least one selected from Al, Mg, Co, Fe, Ni, and Zn), lithium titanate (oxides including Li and Ti), and metallic lithium phosphate (LiMPO₄, where M is at least one selected from Fe, Mn, Co, and Ni). The positive electrode active material layer 112 may further include a conductive aid, a binder, a solid electrolyte, and the like.

The negative electrode layer 12 is a metal layer (including metal foil) in which lithium is deposited on its surface during charging. The negative electrode layer 12 also acts as the negative electrode current collector. The negative electrode layer 12 is connected to the negative electrode tab (not illustrated).

The negative electrode layer 12 is in the form of, for example, foil, a plate, mesh, non-woven fabric, a foam. Examples of the material for the negative electrode layer 12 include copper, a copper alloy, stainless steel, and nickel.

The negative electrode layer 12 may be a film of a metal that does not form an alloy with lithium. Examples of the metal film which can be used as the negative electrode layer 12 include a film of Cu, Ti, Fe, Co, Ni, W or an alloy including these metals. The metal film may have layers of a metal that forms an alloy with lithium and an alloy in a range that allows deposition of lithium. Examples of the metal that forms an alloy with lithium include Mg, Zn, Al, In, Si, Ge, Sn, Ag, Au, Pt, Pd, Pb, Sb, Bi, and an alloy including these metals. The metal film may have a carbon coat film.

The solid electrolyte layer 13 includes a solid electrolyte. The solid electrolyte may be any dielectric having the lithium-ion conductivity. A sulfide solid electrolyte, an oxide solid electrolyte, a nitride solid electrolyte, a halide solid electrolyte, or the like, for example, can be used as the solid electrolyte.

Examples of the sulfide solid electrolyte include Li₂S—P₂S₅, Li₂S—P₂S₅—LiI, and the like. The sulfide solid electrolyte may have an argyrodite type crystal structure.

Examples of the oxide solid electrolyte include a NASICON type oxide, a garnet type oxide, and a perovskite type oxide. Examples of the NASICON type oxide include oxides containing Li, Al, Ti, P, and O (for example, Li_{1.5}Al_{0.5}Ti_{1.5}(PO₄)₃). Examples of the garnet type oxide include oxides containing Li, La, Zr, and O (for example, Li₇La₃Zr₂O₁₂). Examples of the perovskite type oxide include oxides containing Li, La, Ti, and O (for example, LiLaTiO₃).

The intermediate layer 14 has a function of uniformly depositing metallic lithium on the surface of the negative electrode layer 12 during charging. The intermediate layer 14 includes a metal that forms an alloy with lithium, and amorphous carbon, and may further include a binding agent, and the like. Examples of the metal that forms the alloy with lithium are described above. Examples of the amorphous carbon include carbon blacks such as acetylene black, furnace black, Ketjen black, coke, and activated carbon. The amorphous carbon may be easily graphitizable carbon (soft carbon), or may be hardly graphitizable carbon (hard carbon), a carbon nano tube (CNT), fullerene, or graphene. The binding agent may be any material that can improve binding properties, for example, polyvinylidene fluoride (PVDF).

The formation method for an all-solid-state lithium secondary battery of the present embodiment performs charging on the above-described all-solid-state lithium secondary battery 1 at least once

The charging for the first time is high-speed charging in which an average charging current density is within a range of 3.0 mA/cm² or more and 14.0 mA/cm² or less per area of a portion of the negative electrode layer 12 (metal film) facing the positive electrode active material layer 112. The average charging current density may be within a range of 7.5 mA/cm² or more and 11.5 mA/cm² or less. The average charging current density at the C rate may be within a range of 1.0 C or more and 3.5 C or less, or may be within a range of 2.0 C or more and 3.0 or less.

In the formation method for an all-solid-state lithium secondary battery of the present embodiment, since the charging for the first time is performed at the high-speed charging, and the average charging current density is within the above-described range, which is high, a metallic lithium layer having a uniform thickness is formed on the surface of the negative electrode layer 12 after charging. The state of the negative electrode layer 12 during charging will be described with reference to FIGS. 2A to 2C. FIG. 2A is a cross-sectional view illustrating an example of a state at an initial time in the charging for the first time, FIG. 2B is a cross-sectional view illustrating an example of a state at an intermediate time in the charging for the first time, and FIG. 2C is a cross-sectional view illustrating an example of a state at an end time in the charging for the first time.

In the state at the initial time of the charging, as illustrated in FIG. 2A, fine metallic lithium particles 20 are generated on the surface of the negative electrode layer 12. In the formation method for an all-solid-state lithium secondary battery of the present embodiment, since the average current density during the charging for the first time is high, a large number of fine metallic lithium particles 20 are generated on the surface of the negative electrode layer 12 at a time.

In the state at the intermediate time of the charging, as illustrated in FIG. 2B, metallic lithium particles 20 are newly generated, and metallic lithium is deposited on surfaces of the generated metallic lithium particles 20 with the particles as nuclei, so that the metallic lithium particles 20 are coarsened. Since the intermediate layer 14 is disposed on the negative electrode layer 12, the metallic lithium particles 20 are less likely to be coarsened in a laminating direction of the electrode laminate 10, and are coarsened in a direction perpendicular to the laminating direction of the electrode laminate 10.

In the state at the end time of the charging, as illustrated in FIG. 2C, the coarsened metallic lithium particles 20 are connected each other, so that a metallic lithium layer 21 is generated.

During a formation process of the all-solid-state lithium secondary battery, the all-solid-state lithium secondary battery 1 may be pressurized in the laminating direction of the electrode laminate 10. When the all-solid-state lithium secondary battery 1 may be pressurized, in the middle period of the charging, the metallic lithium particles 20 is likely to be coarsened in the direction perpendicular to the laminating direction of the electrode laminate 10, thereby making it easy to generate the metallic lithium layer 21 having a more uniform thickness.

The charging for the first time is preferably performed until a state of charge (SOC) of the all-solid-state lithium secondary battery 1 reaches at least 50% or more. The charging for the first time may be performed until the state of charge of the all-solid-state lithium secondary battery 1 reaches 100%. SOC is a value with a fully charged state of the all-solid-state lithium secondary battery 1 being 100%.

The charging for the first time is stopped at the time when the state of charge (SOC) of the all-solid-state lithium secondary battery 1 reaches 30%, and then, the charging may be performed at low-speed charging in which the charging current density is less than 3.0 mA/cm², until the state of charge gradually reaches 100%. The charging for the first time may be performed at a constant current, or may be performed at a constant voltage.

The all-solid-state lithium secondary battery 1 may be discharged after the charging for the first time. An average discharge current during discharging for the first time may be within a range of 1/40 or more and ⅕ or less of the average charging current during the charging for the first time. The thickness of the metallic lithium layer 21 is uniformly reduced by performing the discharging under milder conditions than the charging, so that the surface of the negative electrode layer 12 is likely to be uniform. The discharging for the first time may be performed at a constant current, or may be performed at a constant voltage.

The all-solid-state lithium secondary battery 1 may be charged again after the discharging for the first time. The charge and discharge conditions for a second time may be the same conditions as the charging and discharging for the first time.

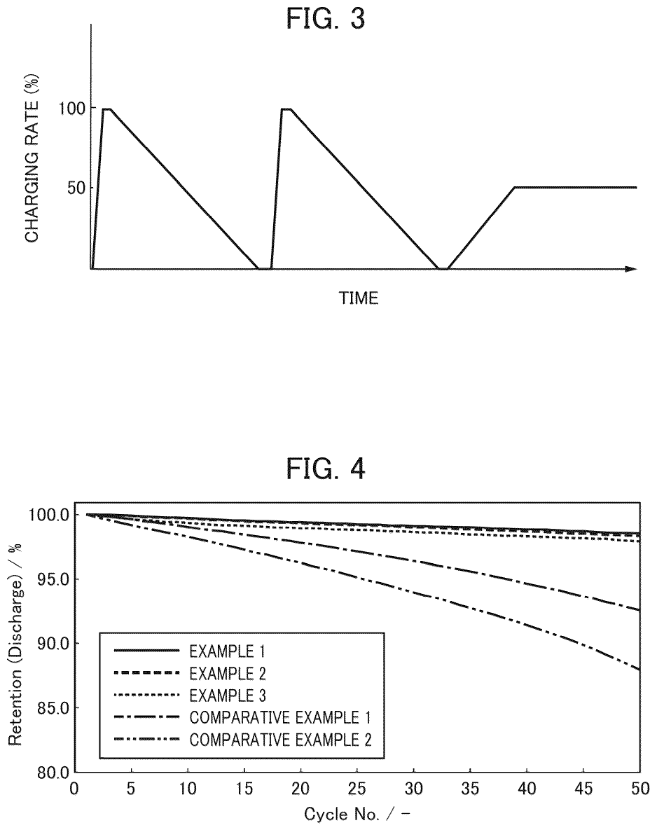

Next, an example of a charging and discharging pattern in the formation method for an all-solid-state lithium secondary battery according to the present embodiment will be described with reference to FIG. 3. FIG. 3 is a graph showing an example of the charging and discharging pattern. In the charging and discharging pattern shown in FIG. 3, the horizontal axis represents a time, and the vertical axis represents of a state of charge of the all-solid-state lithium secondary battery 1.

In the charging and discharging pattern in FIG. 3, the charging for the first time is performed at the high-speed charging until the state of charge reaches 100%. After the charging for the first time, the discharging for the first time is performed until the state of charge reaches 0%. After the discharging for the first time, the charging for the second time is performed at the high-speed charging until the state of charge reaches 100%. After the charging for the second time, the discharging for the second time is performed until the state of charge reaches 0%. After the discharging for the second time, the charging for the third time is performed until the state of charge reaches 50%, and the charged all-solid-state lithium secondary battery 1 is allowed to stand still. The charging for the third time may be performed at the low-speed charging in which the average charging current density is less than 3.0 mA/cm². The environmental temperature during charging and discharging is not limited to a particular temperature, but the charging and discharging may be performed, for example, in a range of 20° C. or more and 60° C. or less.

According to the formation method for an all-solid-state lithium secondary battery of the present embodiment configured as described above, the metallic lithium layer 21 having a uniform thickness is formed on the metal film of the negative electrode layer 12 by the high-speed charging for the first time, so that the surface of the negative electrode layer 12 (metal film) are uniformly activated. Therefore, the cycle characteristics of the all-solid-state lithium secondary battery after the formation process are improved.

In the formation method for an all-solid-state lithium secondary battery of the present embodiment, the surface of the negative electrode layer 12 is uniformly activated more reliably by performing the charging for the first time until the state of charge of the all-solid-state lithium secondary battery 1 reaches 50%, so that the cycle characteristics of the all-solid-state lithium secondary battery after the formation process are further improved. After the charging for the first time, the all-solid-state lithium secondary battery is discharged, and then the high-speed charging for the second time is performed, and thereby the surface of the negative electrode layer 12 is further uniformly activated by the charging for the second time, so that the cycle characteristics of the all-solid-state lithium secondary battery after the formation process are further improved.

In the formation method for an all-solid-state lithium secondary battery of the present embodiment, when the negative electrode layer 12 is a film of a metal that does not form an alloy with lithium, lithium is more easily deposited on the surface of the negative electrode layer 12 during charging, so that the cycle characteristics of the all-solid-state lithium secondary battery after the formation process are further improved. In particular, when the metal film is a copper film, lithium is easily deposited on the surface of the negative electrode layer 12 more reliably during charging, so that the cycle characteristics of the all-solid-state lithium secondary battery after the formation process are further improved. Furthermore, the negative electrode layer 12 is connected to the negative electrode tab (not illustrated), and acts as the negative electrode current collector, and the all-solid-state lithium secondary battery 1 is an anode-free battery, so that a capacity per unit capacity can be increased easily.

Although the embodiment of the present invention has been described above, the present invention is not limited to the above-described embodiment. For example, in the present embodiment, the negative electrode layer 12 is connected to the negative electrode tab (not illustrated), and acts as the negative electrode current collector, but a form of the negative electrode layer is not limited thereto. The negative electrode layer may be a laminate in which a negative electrode current collector and a metal film for depositing lithium are laminated and the metal film is disposed at a position facing the positive electrode active material layer. Further, in the present embodiment, the electrode laminate 10 of the all-solid-state lithium secondary battery 1 includes the intermediate layer 14. However, the present invention is not limited thereto. If the solid electrolyte layer 13 alone is capable of uniformly depositing metallic lithium on the surface of the negative electrode layer during charging, the intermediate layer 14 may be omitted.

### EXAMPLES

The present invention will be described below using examples, but the present invention is not limited to these examples.

[all-Solid-State Lithium Secondary Battery]

An all-solid-state lithium secondary battery used in this example was produced as follows.

### (1) Fabrication of Positive Electrode Layer

As a positive electrode current collector, aluminum foil having a thickness of 15 μm was prepared. Mixed were 80 parts by mass of lithium-nickel-cobalt-manganese composite oxide (NCM622) as a positive electrode active material, 17 parts by mass of argyrodite-type sulfide solid electrolyte as a solid electrolyte material, 2 parts by mass of carbon black as a conductive aid, and 1 part by mass of styrene butadiene rubber (SBR) based binder as a binding agent. A resultant mixture was dispersed in 43 parts by mass of butyl butyrate to prepare a positive electrode active material layer slurry. The obtained positive electrode active material layer slurry was applied to both surfaces of the positive electrode current collector using a bar coater so as to have a mass per unit area of 27 mg/cm² after drying, and was dried to form a positive electrode active material layer having a thickness of 80 μm to fabricate the positive electrode layer.

### (2) Fabrication of Solid Electrolyte Layer Transfer Sheet

Mixed were 97 parts by mass of argyrodite-type sulfide solid electrolyte (median diameter of 3.0 μm) and 3 parts by mass of styrene butadiene rubber (SBR) based binder. A resultant mixture was dispersed in a solvent to prepare a solid electrolyte slurry. The obtained solid electrolyte slurry was applied to a support sheet and dried to fabricate a solid electrolyte layer transfer sheet (thickness of solid electrolyte layer: 100 μm).

### (3) Fabrication of Intermediate Layer Transfer Sheet

Mixed were a total of 95 parts by mass of Sn particles (average particle size: 0.07 μm) as metal particles and acetylene black (average particle size: 0.05 μm) as amorphous carbon particles, and 5 parts by mass of a PVDF-based binder as a binding agent. A resultant mixture was dispersed in 1000 parts by mass of N-methyl-2-pyrrolidone (NMP) to prepare an intermediate layer slurry. The obtained intermediate layer slurry was applied to a support sheet and dried to fabricate an intermediate layer transfer sheet (thickness of intermediate layer: 3.0 μm).

### (4) Negative Electrode Layer

As a negative electrode current collector, copper foil (NC-WS, FURUKAWA ELECTRIC Co., Ltd.) having a thickness of 8 μm was prepared.

(5) Fabrication of all-Solid-State Lithium Secondary Battery

A solid electrolyte layer in the solid electrolyte layer transfer sheet was superimposed on the surface of the positive electrode active material layer in the positive electrode layer, and the solid electrolyte layer and the positive electrode active material layer were joined using a uniaxial molding press device under joining conditions including joining pressure: 70 MPa, joining time: 3 minutes, and joining temperature: room temperature. Then, the support sheet for the solid electrolyte layer transfer sheet was peeled off to obtain a positive electrode layer-solid electrolyte layer assembly. Next, an intermediate layer in the intermediate layer transfer sheet was superimposed on the surface of the solid electrolyte layer in a positive electrode layer-solid electrolyte layer laminate, and the solid electrolyte layer and the intermediate layer were joined using a uniaxial molding press device under joining conditions including joining pressure: 110 MPa, joining time: 5 minutes, and joining temperature: room temperature. Then, the support sheet for the intermediate layer transfer sheet was peeled off to obtain a positive electrode layer-solid electrolyte layer-intermediate layer assembly. Next, using an isotropic pressure molding press device, the positive electrode layer-solid electrolyte layer-intermediate layer assembly was densified under joining pressure: 980 MPa, joining time: 5 minutes, and joining temperature: 120° C. Next, the negative electrode current collector in the negative electrode layer was superimposed on the surface of the intermediate layer in a positive electrode layer-solid electrolyte layer-intermediate layer assembly to obtain an electrode laminate. The obtained electrode laminate was housed in an aluminum laminate film exterior housing body to fabricate an all-solid-state lithium secondary battery. A buffer was disposed on the negative electrode layer side, and was constrained under a constraining pressure of 3 MPa.

### Example 1

The formation process was performed on the above-described all-solid-state lithium secondary battery as follows. First, the all-solid-state lithium secondary battery was placed in a constant temperature bath at 60° C., and was allowed to stand still for 4 hours. Next, in the constant temperature bath, the all-solid-state lithium secondary battery was charged and discharged under the following conditions.

### (Charging and Discharging Conditions)

Charging for a first time: The constant current charging was performed at the current density of 3.80 mA/cm² (1 C) until the battery voltage reached 4.3 V, and then, the constant voltage charging was performed at the battery voltage of 4.3 V until the current density of the charging current reached 0.19 mA/cm² (0.05 C) or less (SOC: 100%). Discharging for a first time: After the charging was completed, the battery was allowed to stand still for 15 minutes. Next, the constant current discharging was performed at the current density of 0.38 mA/cm² (0.1 C) until the battery voltage reached 2.65 V (SOC: 0%). Charging for a second time: After the discharging was completed, the battery was allowed to stand still for 30 minutes. Next, the constant current charging was performed at the current density of 3.80 mA/cm² (1 C) until the battery voltage reached 4.3 V, and then, the constant voltage charging was performed at the battery voltage of 4.3 V until the current density of the charging current reached 0.19 mA/cm² (0.05 C) or less (SOC: 100%).

### Examples 2 and 3, and Comparative Examples 1 and 2

The formation process was performed on the all-solid-state lithium secondary battery in the same way as Example 1 except that the current density in the charging for the first time and the charging for the second time was changed to the current density shown in the following Table 1.

### [Table 1]

### [Evaluation]

Regarding the all-solid-state lithium secondary battery after the formation process, the DC resistance (DCR) and the cycle characteristics were measured by the following methods.

### (DC Resistance)

The constant current and constant voltage (CC and CV) charging was performed on the all-solid-state lithium secondary battery until the SOC reached 50% under the conditions including temperature: 60° C., current density: 0.38 mA/cm² (0.1 C), and voltage: voltage equivalent to SOC 50%. After the charging, the all-solid-state lithium secondary battery was discharged at the temperature of 25° C. and the current density of 15.1 mA/cm², and the initial DC resistance of the all-solid-state lithium secondary battery was calculated by the following formula using the voltage drop ΔV (V) during the discharging, the current value I (A), and the positive electrode area Ac (cm²). The results are shown in the following Table 2. Initial DC resistance (Q·cm²)=Voltage drop ΔV (V)/Current value I (A)×Positive electrode area Ac (cm²)

### [Table 2]

### (Cycle Characteristics)

The charging and discharging cycle test was performed in which the charging was performed at the constant current and constant voltage (CCCV) and the discharging was performed at the constant current (CC) under the temperature of 45° C., the current density of 1.3 mA/cm² (⅓C), and the voltage range from an upper-limit voltage of 4.3 V to a lower-limit voltage 2.65 V. The discharge capacity retention rate of each cycle is shown in FIG. 4.

From the results in Table 2 and FIG. 4, it was found that in the all-solid-state lithium secondary battery of each of Examples 1 to 3 in which the charging was performed at the state of charge according to the present invention, a DC resistance was low, a discharge capacity retention rate when the charging and discharging cycle was repeated was high, and thus the cycle characteristics were improved. In contrast, in the all-solid-state lithium secondary battery of Comparative Example 1 in which the charging current density during the formation process was lower than that of the present invention, the DC resistance was higher than that of the present invention. This is because during the charging in the formation process, due to the small number of lithium particles deposited on the surface of the negative electrode layer (copper film), the surface of the negative electrode layer was not sufficiently activated. In the all-solid-state lithium secondary battery of Comparative Example 2 in which the charging current density during the formation process was higher than that of the present invention, the cycle characteristics were deteriorated. It is conceivable that due to an excessively high charging current density, the constant voltage charging time was increased, causing acceleration of the oxidation degradation of the solid electrolyte of the positive electrode layer, and the reaction heterogeneity in the positive electrode active material layer was accelerated, causing local acceleration of the deterioration.

### EXPLANATION OF REFERENCE NUMERALS

1 All-solid-state lithium secondary battery
10 Electrode laminate
11 Positive electrode layer
111 Positive electrode current collector
112 Positive electrode active material layer
12 Negative electrode layer
13 Solid electrolyte layer
14 Intermediate layer
20 Metallic lithium particles
21 Metallic lithium layer

What is claimed is:

1. A formation method for an all-solid-state lithium secondary battery including a positive electrode layer, a negative electrode layer, and a solid electrolyte layer disposed between the positive electrode layer and the negative electrode layer, wherein the positive electrode layer has a positive electrode current collector, and a positive electrode active material layer, the negative electrode layer has a metal film, the metal film is disposed at a position facing the positive electrode active material layer, and lithium is deposited on a surface of the metal film during charging, the method comprising:
performing charging at least once,
wherein an average charging current density in the charging for a first time falls within a range of 3.0 mA/cm² or more and 14.0 mA/cm² or less per area of a portion of the metal film facing the positive electrode active material layer.

2. The formation method for an all-solid-state lithium secondary battery according to claim 1, wherein
the charging for the first time is performed until a state of charge of the all-solid-state lithium secondary battery reaches at least 30%.

3. The formation method for an all-solid-state lithium secondary battery according to claim 1, wherein
after the charging for the first time, the all-solid-state lithium secondary battery is discharged, and then, charging for a second time is performed on the all-solid-state lithium secondary battery under a condition that an average charging current density is within a range of 3.0 mA/cm² or more and 14.0 mA/cm² or less per area of a portion of the metal film facing the positive electrode active material layer.

4. The formation method for an all-solid-state lithium secondary battery according to claim 1, wherein
the metal film is a film of a metal that does not form an alloy with lithium.

5. The formation method for an all-solid-state lithium secondary battery according to claim 4, wherein
the metal film is a copper film.

6. The formation method for an all-solid-state lithium secondary battery according to claim 1, wherein
the all-solid-state lithium secondary battery has a negative electrode tab, and the negative electrode tab is connected to the metal film.
